(19) United States
(12) Patent Application Publication
(10) Pub. No.: US 2026/0217556 A1
(43) Pub. Date: Jul. 30, 2026

(54) SULFOCHLORIDES AS INTERCALATION MATERIALS

(71) Applicant: The Trustees of Boston College, Chestnut Hill, MA (US)

(72) Inventors: Alexis Grimaud, Cambridge, MA (US); Michael Spencer, Newton, MA (US)

(21) Appl. No.: 19/464,382

(22) Filed: Jan. 29, 2026

Related U.S. Application Data
(60) Provisional application No. 63/751,747, filed on Jan. 30, 2025.

(51) Int. Cl. C01G 45/22; H01M 4/02; H01M 4/58; H01M 10/0525; H01M 10/054; H01M 10/0568; H01M 10/0569

(52) U.S. Cl. CPC C01G 45/22; H01M 4/582; H01M 10/0525; H01M 10/054; H01M 10/0568; H01M 10/0569; C01P 2002/72; C01P 2006/40; H01M 2004/028; H01M 2300/0028

(57) ABSTRACT

Electrode materials for Li-ion batteries, Na-ion batteries, or K-ion batteries. Provided are materials that show enhanced capacity towards Li, Na, or K reactivity represented by formula AxTM1yTM2zSaClb, A being Li, Na, or K, TM1 and TM2 being 3d (Ti, V, Cr, Mn, Fe, Co, Ni, Cu), 4d (Nb, Mo, Ru, Rh) or 5d (W, Re, Os, Ir) transition metals, and x, y, z, a, and b being numbers of atoms. Also disclosed are batteries comprising the electrode materials.

### CROSS-REFERENCE TO RELATED APPLICATIONS

This application claims the benefit of and priority to U.S. Provisional Patent Application Ser. No. 63/751,747, filed on Jan. 30, 2025. The content of the prior applications is hereby incorporated by reference in its entirety.

### STATEMENT REGARDING FEDERALLY SPONSORED RESEARCH

This invention was made with government support under CBET-2524721 awarded by the National Science Foundation. The government has certain rights in the invention.

### BACKGROUND

Recent efforts in the development of high energy density intercalation materials for Li-ion batteries have focused on increasing the amount of Li exchanged beyond one Li per formula unit (f.u.), leading to the development of Li-rich materials with general formula Li₂MX₃ (M is a transition metal and X is O or S) having a high capacity. Charge compensation for materials that exchange more than one Li⁺ per f.u. can be achieved by multi-electron transition metal (TM) redox (M²⁺/M⁴⁺), multi-electron anion redox (O²⁻/O⁻ or S²⁻/S₂²⁻), or by combining single-electron TM (M³⁺/M⁴⁺) and anionic (O²⁻/O⁻ or S²⁻/S₂²⁻) redox couples. A critical challenge for TM chalcogenide intercalation materials is the difficulty in enabling multi-electron redox activity without triggering copious side reactions or irreversible structural transformations that hamper their long-term stability. Substitution chemistry strategies were heavily pursued to optimize physical and chemical properties of intercalation materials, with the understanding that subtle differences in redox activity are observed when substituting the transition metals. Studies have demonstrated that triggering anionic redox in TM oxides induces poor reversibility and poor kinetics, contributing to capacity and voltage decay upon cycling.

On the other hand, mixed-anion intercalation materials remain underexplored. Most reports on mixed anion compounds for electrochemical energy storage involve substitution of anions with the same valence (e.g., forming mixed anion compounds of oxygen, sulfur, and/or selenium). In reported cases, incorporation of anionic ligands leads to a decrease in the redox potential, such as A₂MChO (A=Li, Na; M=transition metal; Ch=S, Se), selenium-substituted Li-rich TM sulfides, transition metal oxychlorides, and oxynitrides. However, these materials are often limited to the exchange of <1 Li⁺/f.u., undergo conversion/displacement reactions, and/or face steep challenges regarding stability in liquid electrolytes.

Toward achieving the goal of exchanging >1 Li⁺/f.u., fluorine ligands (F⁻) have been used for substituting oxygen ligands (O²⁻). This strategy is accompanied by severe drawbacks associated with the limited solubility of fluorine into oxides, the formation of Li—F clusters that impede Li⁺ transport, and the reactivity of oxyfluorides with liquid electrolytes at high potentials.

The need exists to produce electrode material without the drawbacks discussed above.

### SUMMARY

To meet this need, an electrode material is provided that has the formula AₓTM1_{y}TM2_{z}SₐCl_{b}, in which A is Li, Na, or K, TM1 and TM2 are the same or different and are each selected from a 3d, 4d, and 5d transition metal, x is 0 to 2.5, the sum of y and z is 1, the sum of a and b is 3, and b is greater than 0. The 3d transition metal can be Ti, V, Cr, Mn, Fe, Co, Ni, or Cu; the 4d transition metal can be Nb, Mo, Ru, or Rh; and the 5d transition metal can be W, Re, Os, or Ir.

Also provided is a battery comprising a positive electrode, a negative electrode, and an electrolyte, wherein the positive electrode contains the electrode material of claim 1.

The details of one or more embodiments are set forth in the description and the examples below. Other features, objects, and advantages will be apparent from the detailed description, from the drawings, and also from the appended claims.

### BRIEF DESCRIPTION OF THE DRAWINGS

The description below refers to the accompanying drawings, of which:

FIG. 1 shows X-ray diffraction results for Li₂Ti_{0.5}Mn_{0.5}S₂Cl and Li₂Ti_{0.5}Fe_{0.5}S₂Cl with peaks matching the cubic Fm3̅m structure;

FIG. 2 shows electrochemical exchange of Li recorded for Li₂Ti_{0.5}M_{0.5}S₂Cl (M is Fe or Mn) in superconcentrated 5 M LiFSI in DMC electrolyte at a rate of C/10 (1 Li exchanged every 10 hours) at 298 K;

FIG. 3 shows voltage profiles and dQ/dV curves of Li₂Ti_{0.5}Mn_{0.5}S₂Cl and Li₂TiS₃ cycled in 5 M LiFSI in DMC at a C/10 rate based on 1 Li⁺/f.u.

FIG. 4 shows schematic molecular orbitals formed for Metal-Sulfur vs Metal-Chloride bonds, with a downshift in energy for the antibonding MCl* states when compared to MS* states due to the increased electronegativity of the chlorine ligand and the increased ionicity of the M-Cl bond;

FIG. 5A shows ex situ XAS results for Li₂Ti_{0.5}Mn_{0.5}S₂Cl at the K-edge of Cl during the first charge;

FIG. 5B shows ex situ XAS results for Li₂Ti_{0.5}Mn_{0.5}S₂Cl at the K-edge of Ti during the first charge;

FIG. 5C shows ex situ XAS results for Li₂Ti_{0.5}Mn_{0.5}S₂Cl at the K-edge of Mn during the first charge;

FIG. 5D shows ex situ XAS results for Li₂Ti_{0.5}Mn_{0.5}S₂Cl at the K-edge of Cl during the first charge;

FIG. 6 is a schematic band diagram showing the shift of the S/Cl band position in relation to the pure S p band leading to the redox potential shift;

FIG. 7A shows ex situ XAS results for Li₂Ti_{0.5}Mn_{0.5}S₂Cl at the K-edge of Ti during the first discharge;

FIG. 7B shows ex situ XAS results for Li₂Ti_{0.5}Mn_{0.5}S₂Cl at the K-edge of Mn during the first discharge;

FIG. 7C shows ex situ XAS results for Li₂Ti_{0.5}Mn_{0.5}S₂Cl at the K-edge of S during the first discharge;

FIG. 7D shows ex situ XAS results for Li₂Ti_{0.5}Mn_{0.5}S₂Cl at the K-edge of Cl during the first discharge;

FIG. 8A shows operando XRD recorded during the first cycle for Li₂Ti_{0.5}Mn_{0.5}S₂Cl at C/10. Highlighted diffractograms correspond to specific lithium content x, as shown in the evolution of the potential over time on the right panel;

FIG. 8B shows the evolution of the lattice parameter recorded during cycling;

FIG. 8C is a Waterfall plot showing the reversible loss of intensity for selected reflections during first two cycles. Highlighted Diffractograms correspond to the beginning and the end of the first cycle, and the end of the second cycle;

FIG. 9A shows X-ray absorption data recorded at the Mn K-edge for the pristine Li₂Ti_{0.5}Mn_{0.5}S₂Cl sample, compared to samples oxidized and reduced at different states;

FIG. 9B shows X-ray absorption data recorded at the Ti K-edge for the pristine Li₂Ti_{0.5}Mn_{0.5}S₂Cl sample, compared to samples oxidized and reduced at different states;

FIG. 10 shows voltage profiles of Li₂Ti_{0.5}Mn_{0.5}S₂Cl pristine, washed with DMC and synthetized using MnCl₂ instead of LiCl as precursor, all cycled in 5 M LiFSI in DMC at a C/10 rate based on 1 Li⁺/f.u;

FIG. 11 shows cycling data recorded for LTMSC in 5M LiFSI in DMC at C/10. First cycle starts with a reduction down to 1.2 V vs. Li/Li⁺ to form a CEI on the surface of the material before cycling between 1.5-3.5 V vs. Li/Li⁺ in the subsequent cycles;

FIG. 12A shows voltage profiles for Li₂Ti_{0.5}Mn_{0.5}S₂Cl recorded at a C/10 rate based on 1 Li⁺/f.u in 5 M LiFSI in DMC;

FIG. 12B shows voltage profiles for Li₂Ti_{0.5}Mn_{0.5}S₂Cl recorded at a C/10 rate based on 1 Li⁺/f.u in 5 M LiFSI in DMC with the addition of 1 wt % of lithium difluoro (oxalate)borate (LiODFB) and 0.5 wt % of tris(pentafluorophenyl)borane (TPFPB);

FIG. 12C shows voltage profiles for Li₂Ti_{0.5}Mn_{0.5}S₂Cl recorded at a C/10 rate based on 1 Li⁺/f.u in 5 M LiFSI in DMC with the addition of 1 wt % of ODFB, 0.5 wt % of TPFPB with activated carbon added to the electrode;

FIG. 12D shows charge and discharge capacity recorded for Li₂Ti_{0.5}Mn_{0.5}S₂Cl in 5 M LiFSI in DMC with 1 wt % of LiODFB, 0.5 wt % of TPFPB, and activated carbon added to the electrode mix;

FIG. 13A shows voltage profiles and dQ/dV curves of Li₂Nb_{0.33}Mn_{0.66}S₂Cl and Li₂TiS₃ cycled in 5 M LiFSI in DMC at a C/10 rate based on 1 Li⁺/f.u during the first charge;

FIG. 13B is a schematic band diagram showing the relative position of the Mn(3d) states compared to the non-bonding S 2p states;

FIG. 13C shows ex situ XAS results for Li₂Nb_{0.33}Mn_{0.66}S₂Cl at the K-edge of Cl during the first charge;

FIG. 13D shows ex situ XAS results for Li₂Nb_{0.33}Mn_{0.66}S₂Cl at the K-edge of Nb during the first charge;

FIG. 13E shows ex situ XAS results for Li₂Nb_{0.33}Mn_{0.66}S₂Cl at the K-edge of Mn during the first charge;

FIG. 13F shows ex situ XAS results for Li₂Nb_{0.33}Mn_{0.66}S₂Cl at the K-edge of S during the first charge; and

FIG. 14 shows voltage profiles of Li₂Mo_{0.25}Mn_{0.55}S₂Cl cycled in 5 M LiFSI in DMC at a C/10 rate based on 1 Li⁺/f.u.

### DETAILED DESCRIPTION

As mentioned in the SUMMARY section, an electrode material is disclosed having the formula AₓTM1_{y}TM2_{z}SₐCl_{b}, in which A is Li, Na, or K. In a preferred embodiment, A is Li.

In the formula AₓTM1_{y}TM2_{z}SₐCl_{b}, x is 0 to 2.5 (e.g., 0 to 2, 0.1 to 2, 0, 0.25, 0.5, 0.75, 1, 1.25, 1.5, 1.75, and 2); y can be 0 to 1 (e.g., 0.1 to 0.9, 0.15 to 0.8, 0.2 to 0.6, 0, 0.25, 0.33, 0.5, 0.67, 0.75, and 1); z can be 0 to 1 (e.g., 0.9 to 0.1, 0.2 to 0.95, 0.3 to 0.9, 0.4 to 0.85, 0.5 to 0.8, 0, 0.25, 0.33, 0.5, 0.67, 0.75, and 1); the sum of y and z is 1; a is 1 to 2.9 (e.g., 1.2 to 2.8, 1.5 to 2.7, 1.8 to 2.6, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, and 2.9), b is 0.1 to 2 (e.g., 0.2 to 1.8, 0.3 to 1.5, 0.4 to 1.2, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, and 2); and the sum of a and b is 3.

TM1 and TM2 are the same or different and are each selected from a 3d, 4d, and 5d transition metal. In particular embodiments, the 3d transition metal can be Ti, V, Cr, Mn, Fe, Co, Ni, or Cu; the 4d transition metal can be Nb, Mo, Ru, or Rh; and the 5d transition metal can be W, Re, Os, or Ir. In preferred embodiments, TM1 is Ti, Nb, or Mo, and TM2 is Mn.

In a particular embodiment of the electrode material, TM1 is Ti, TM2 is Mn, y is 0 to 1, z is 0 to 1, a is 1 to 2.9, and b is 0.1 to 2. In another embodiment, TM1 is Nb, TM2 is Mn, y is 0 to 1, z is 0 to 1, a is 1 to 2.9, and b is 0.1 to 2.

The electrode material of the invention can have the formula LiₓTM1_{1-z}Mn_{z}SₐCl₃₋ₐ, in which TM1 is Ti or Nb, x is 0 to 2.5 (e.g., 0, 0.25, 0.5, 0.75, 1.0, 1.25, 1.5, 1.75, 2, 2.25), 2.5), z is 0.25 to 0.75 (e.g., 0, 0.25, 0.5, and 0.75), and a is 2 to 2.5 (e.g., 2, 2.1, 2.2, 2.3, 2.4, and 2.5).

Specific electrode materials encompassed by the invention are LiₓTi_{0.5}Mn_{0.5}S₂Cl, LiₓTi_{0.25}Mn_{0.75}S_{2.5}Cl_{0.5}, LiₓNb_{0.5}Mn_{0.5}S_{2.5}Cl_{0.5}, LiₓNb_{0.33}Mn_{0.67}S₂Cl, and LiₓMo_{0.25}Mn_{0.55}S₂Cl, in which x is 0 to 2.

The electrode material can have a cation-disordered rock salt (DRX) structure or a layered structure. A particular electrode material has a DRX structure. The electrode material can have an Fm3̅m structure or a R3̅m structure.

Also within the scope of the invention is a battery comprising a positive electrode, a negative electrode, and an electrolyte in which the positive electrode contains the electrode material described above.

In addition to the above electrode material, the positive electrode can also include a conducting carbon additive that can be carbon black, graphene, or carbon nanotubes, and can also include a binder such as poly(vinylidene difluoride), polytetrafluoroethylene, polyvinyl alcohol, carboxymethyl cellulose, and mixtures thereof.

The negative electrode can include, for example, lithium, sodium, graphite, silicon, or any combination of these elements.

In certain embodiments of the battery, the electrolyte contains a salt that can be, but is not limited to, LiClO₄, LiPF₆, LiBF₄, LiSbF₆, LiCF₃SO₃, LiN(SO₂CF₃)₂, LiN(SO₂C₂F₅)₂, LiN(SO₂F)₂, LiC(SO₂CF₃)₃, Li[N(SO₂C₄F₉)(SO₂F)], LiAlO₄, LiAlCl₄, LiCl, LiI, lithium bis(oxalato)borate, lithium bis(fluorosulfonyl)imide (LiFSI), NaClO₄, NaPF, NaBF₄, NaSbF₆, NaCF₃SO₃, NaN(SO₂CF₃)₂, NaN(SO₂C₂F₅)₂, NaN(SO₂F)₂, NaC(SO₂CF₃)₃, Na[N(SO₂C₄F₉)(SO₂F)], NaAlO₄, NaAlCl₄, NaCl, NaI, sodium bis(oxalato)borate, sodium bis(fluorosulfonyl)imide (NaFSI), and a combination thereof. Preferably, the salt is LiFSI or NaFSI.

The salts mentioned above can be dissolved or suspended in a carbonate, an ether, an ester, a ketone, a nitrile, or a combination of these solvents. For example, the solvent can be, but is not limited to, dimethyl carbonate (DMC) or dimethoxyethane (DME).

In a particular embodiment, the electrolyte is LiFSI or NaFSI dissolved in dimethyl carbonate (DMC) or dimethoxyethane (DME).

In particular embodiments, the electrolyte has a salt concentration of at least 3 mol/L, preferably 4.5 mol/L to 10 mol/L (4.5, 5, 5.5, 6, 6.5, 7, 7.5, 8, 8.5, 9, 9.5, and 10 mol/L).

The battery described above can be rechargeable.

Not to be bound by theory, one central hypothesis is that DRX sulfochlorides can achieve reversible multi-electron transition metal redox by offsetting some anionic redox thus alleviating the limitations encountered by Li-rich sulfide materials (limited operating voltage) and those faced by oxyfluoride DRX materials (instability at high potentials).

Without further elaboration, it is believed that one skilled in the art can, based on the disclosure herein, utilize the present disclosure to its fullest extent. The following specific examples are, therefore, to be construed as merely descriptive, and not limitative of the remainder of the disclosure in any way whatsoever. All publications and patent documents cited herein are incorporated by reference in their entirety.

### EXAMPLES

### Example 1: Materials and Methods

### Chemicals

Li₂S (Thermo Scientific®, 99.9%), LiCl (Thermo Scientific®, 99%) TiS₂ (Strem® Catalog, 99.8% metals basis), S (Sigma Aldrich®, 99.998%), Nb (Sigma Aldrich®, 99.8% metals basis), MnCl₂ (Thermo Scientific®, 99.99% metals basis), FeS (Thermo Scientific®, 99.9% metals basis) MnS (Thermo Scientific®, 99.9% metals basis) were purchased and used without additional treatment. Tris-(pentafluorophenyl)borane (Strem® Catalog, min. 97%), Lithium difluoro(oxalato)borate (Sigma Aldrich®), super P carbon (Thermo Scientific®, 99+% metals basis), activated carbon (Sigma Aldrich®) were purchased and dried under vacuum at 70-100° C. before use.

Synthesis of DRX-Li₂MₓMn₁₋ₓS₂Cl Phases

Li₂M^{I}₁₋ₓM^{II}ₓS₂Cl (M=Ti, Nb) materials were synthesized following the mechano-chemical synthesis procedure described below.

Typically, a stoichiometric amount of precursors were processed as follows: (1) mixing using mortar and pestle; (2) transferring to a hardened stainless steel ball mill vial (Cole-Parmer SamplePrep® 8009); and (3) ball milling for 10 cycles with 2 hours of milling and 15 minutes of resting per cycle (Spex SamplePrep®). Steps 1 and 2 were conducted in an argon-filled glovebox (MBraun®, <0.5 ppm of H₂O, O₂). Note that Li₂Nb_{0.33}Mn_{0.67}S₂Cl was synthesized using a stoichiometric amount of Li₃NbS₄, LiCl, and MnS.

### Material Characterization

XRD measurements were performed using a Bruker® D8 Advance with Cu Kα source (λ=1.54056 Å) using an airtight sample holder with a Kapton window. The Bruker® LeRiChe'S Cell v2 cell was used to perform operando electrochemical XRD measurements. The cell assembly included a Be window, a 3 μm Al foil protective layer, 70:30 wt % active material to Super P powder electrode, Whatman® glass fiber separator, 5 M LiFSI in DMC electrolyte, Li foil, a stainless-steel spacer, and a stainless-steel plunger. Le Bail fitting was performed in the FullProf Suite® (version 5.10, 2023). Crystal structure illustrations were produced using VESTA.

HAADF/STEM imaging was performed on a Thermo Fisher Scientific Themis® Z G3 Cs-corrected scanning transmission electron microscope. Elemental mapping was collected with a Super X-4 quadrant energy dispersive X-ray spectroscopy (EDS) detector. Sample preparation included ~30 minutes sonication in hexanes followed by drop casting on a copper grid coated with lacey carbon (Oxford Instruments). In a nitrogen-filled glovebox, sample grids were loaded in a Mel-Build Atmos Double Tilt LN2® Vacuum/Inert Gas Transfer Holder and subsequently transferred to the TEM to avoid exposure to air and moisture. High-angle annular dark field images and EDS mapping data were collected at 200 kV.

X-ray absorption spectroscopy (XAS) measurements were performed at the National Synchrotron Light Source II at Brookhaven National Laboratory using beamlines QAS (7-BM) and TES (8-BM). Ti, Mn, and Fe K-edge measurements were collected in transmission mode. Samples were prepared by sealing pellets of the active material and carbon between two pieces of Kapton tape (thickness=0.5 mil, Bertech). S and Cl K-edge measurements were collected in fluorescence mode. Samples were mixed with polyethylene oxide in a mortar and pestle, pressed into pellets, and sealed between Kapton tape and thin (3 μm) Mylar film (Premier Lab Supply). The relevant metal foils were used as calibration samples for hard X-ray measurements. For tender X-ray measurements, LiCl, Li₂S, MnS, MnCl₂, TiS₂, synthesized Li₃NbS₄ were used as reference samples.

Operando imaging was performed in a custom-designed electrochemical cell with an optical window aligned to the working electrode. Imaging was performed on a standard wide-field optical microscope configured for bright-field reflection geometry. An upright microscope body equipped with a long-working distance objective was used to access the electrode surface through the glass substrate. A 50× objective (numerical aperture NA=0.7, working distance≥3 mm) was employed to achieve an effective lateral spatial resolution of ~2 μm at the electrode plane. Illumination was provided by a stabilized broadband white-light LED source coupled into the microscope's Köhler illumination path. The illumination intensity was adjusted to avoid detector saturation and minimize photothermal perturbation of the cell. A non-polarizing beamsplitter directed light to the sample and collected the reflected signal. To improve contrast and reduce specular reflections, an adjustable aperture diaphragm was used to control the illumination NA. The microscope was equipped with a scientific CMOS (sCMOS; Thorlabs) camera (pixel size 6.5 μm, 16-bit depth). The field of view at 20× magnification was typically ~400×400 μm², corresponding to a region spanning many agglomerates. Electrochemical control was provided by a multi-channel potentiostat (Gamry®) connected to the operando cell. Image processing was performed using custom scripts in Python. Raw images were first corrected for uneven illumination and camera offset by dividing by a flat-field image and subtraconting a dark frame, respectively. To normalize for slow changes in overall intensity (e.g., due to LED drift), each frame was divided by the spatial average intensity over a region free of electrochemically active material. For visualization, images were downsampled to yield an effective pixel size of ~2 μm (e.g., by block averaging or Gaussian smoothing followed by decimation). This step improved signal-to-noise and matched the validated optical resolution, ensuring that reported spatial features were physically meaningful rather than undersampled. Automated particle detection and tracking were performed using custom image-processing routines implemented in Python with the OpenCV library.

### Electrochemical Characterization

Typical electrochemical measurements were performed using CR2032 coin cells (TMAX) and tested on Bio-Logic BCS-805 battery cycler or Neware battery cyclers. Cathode powder electrodes were prepared by mixing 70 wt % active material with 30 wt % Super P carbon. For electrode optimization, Super P carbon was partially substituted for a specified amount of activated carbon which resulted in a weight ratio of active material:super P carbon:activated carbon=70:20:10. All coin cells were assembled in an argon-filled glovebox with <0.1 ppm O₂/H₂O (MBraun Unilab Pro®).

### Computational Details

Spin-polarized Density functional theory (DFT) calculations, as implemented in Vienna Ab initio Simulation Package (VASP) were performed, using the projected augmented wave (PAW) method. The generalized gradient approximation, as parameterized by Perdew, Burke and Ernzerhof (PBE) Click or tap here to enter text. was used in conjunction with the rotationally invariant Dudarev method (DFT+U) to better describe the Mn d-electrons (U_{eff}=4.0 eV). For all calculations, a plane wave basis set with an energy cut-off of 600 eV and a k-mesh grid of 50 k-points/Å were used. The structural relaxations were converged to 5.10⁻³ eV Å⁻¹ for the atomic forces. Supercells with 96 atoms per unit cell (32Li, 8Ti, 8Mn, 32S, 16Cl) were considered to account for Li/Ti/Mn cationic disorder.

### Example 2: Li DRX Sulfochloride Synthesis

Sulfochloride DRX materials were synthesized from commercially available precursors, including LiCl, Li₂S, and transition metal chlorides and sulfides, following the reaction: Li₂S+2LiCl+TiS₂+MnS=2Li₂Ti_{0.5}Mn_{0.5}S₂Cl, with M=Fe, Mn. DRX sulfochlorides were synthesized by ball-milling for 20 hours. Laboratory X-ray diffraction (XRD) confirmed the formation of phase pure rock salt structure with space group Fm3̅m (a=5 . . . 128) Å. See FIG. 1.

Scanning transmission electron miscopy (STEM) imaging coupled with energy dispersive X-ray spectroscopy (EDS) showed uniform mixing of all elements, while a thin chlorine-rich coating was observed on the surface of Li₂Ti_{0.5}Mn_{0.5}S₂Cl (LTMSC) and attributed to LiCl that was not fully incorporated. This is consistent with previous observations of incomplete LiF mixing in DRX transition metal oxyfluorides, and the thin LiCl coating was readily washed off with acetone.

### Example 3: Electrical Behavior of DRX Sulfochlorides

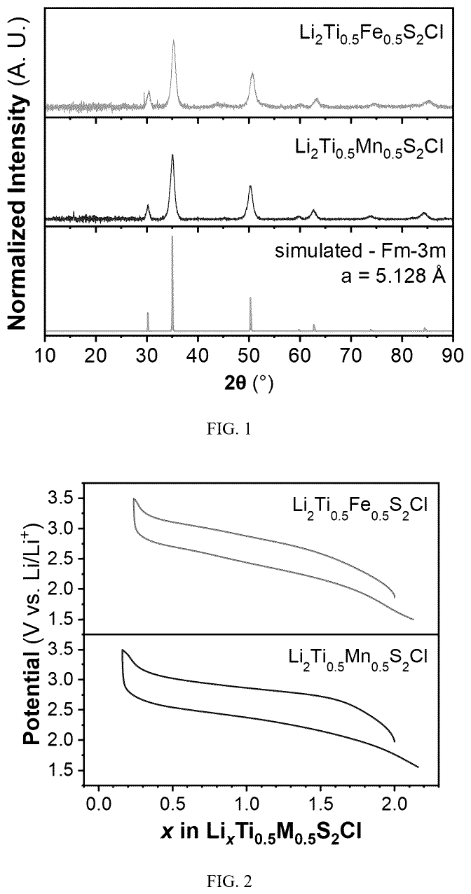

The electrochemical behavior of the Li-rich TM sulfochlorides was studied using a superconcentrated electrolyte, 5 M lithium bis(fluorosulfonyl)imide (LiFSI) in dimethyl carbonate (DMC) to avoid dissolution of chloride-containing material. At a C/10 charge/discharge rate (based on the capacity of exchanging 1 Li⁺/f.u.), ~1.8 Li can be reversibly (de) inserted, delivering a reversible capacity of 292 mAh/g (theoretical capacity of 325 mAh/g). See FIG. 2. This result indicates that two redox centers are active during (de)lithiation. First, reversible 2-electron TM redox (Mn²⁺/Mn⁴⁺ or Fe²⁺/Fe⁴⁺) accounts for the exchange of 1 Li. The second Li is accounted for by the anionic (S²⁻/S₂²⁻) sulfur redox couple.

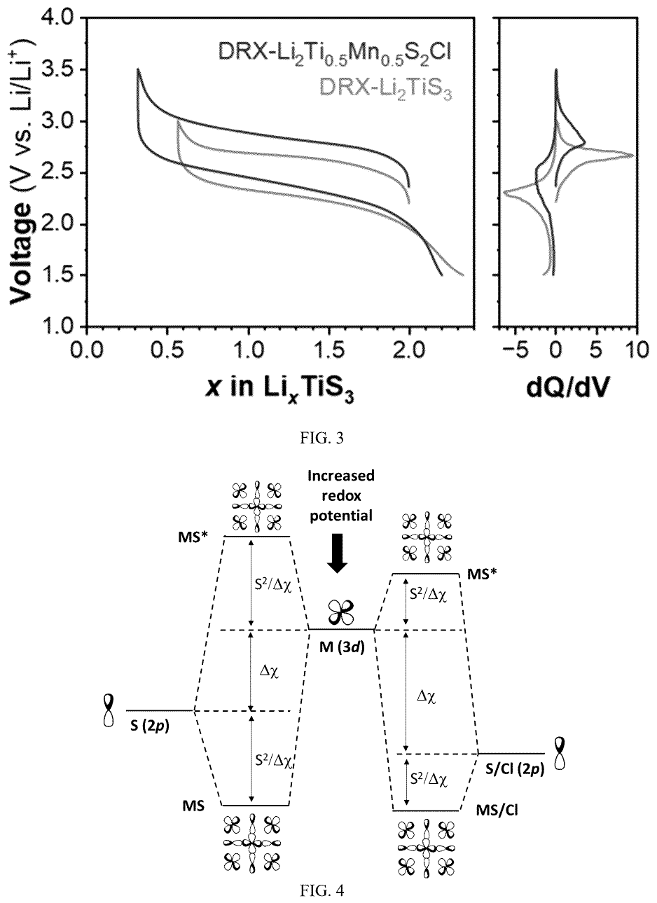

The as-synthesized LTMSC was also cycled in 5 M LiFSI to compare with DRX-Li₂TiS₃. The results are shown in FIG. 3. The initial charge and discharge capacities of LTMSC were 274 mAh g⁻¹ (~1.7 Li⁺/f.u) and 307 mAh g⁻¹ (~1.9 Li⁺/f.u.), respectively, the difference corresponding to the amount of unreacted LiCl observed by STEM/EDS (approximatively 10%). The successful chlorine substitution is evidenced by a shift of the LTMSC redox potential toward higher potentials compared to that of DRX-Li₂TiS₃, as a result of the greater electronegativity of chlorine ligand when compared to sulfur (χ_{Cl}=3.16 vs χ_{S}=2.58 in the Pauling scale). Furthermore, two redox events are observed in LTMSC; two oxidation peaks in charge that are mostly overlapping, followed by two broad but distinguishable reduction peaks in discharge. This is in stark contrast to previously reported results for DRX Li₂TiS₃ that is solely dependent on anion redox during Li-ion (de)insertion.

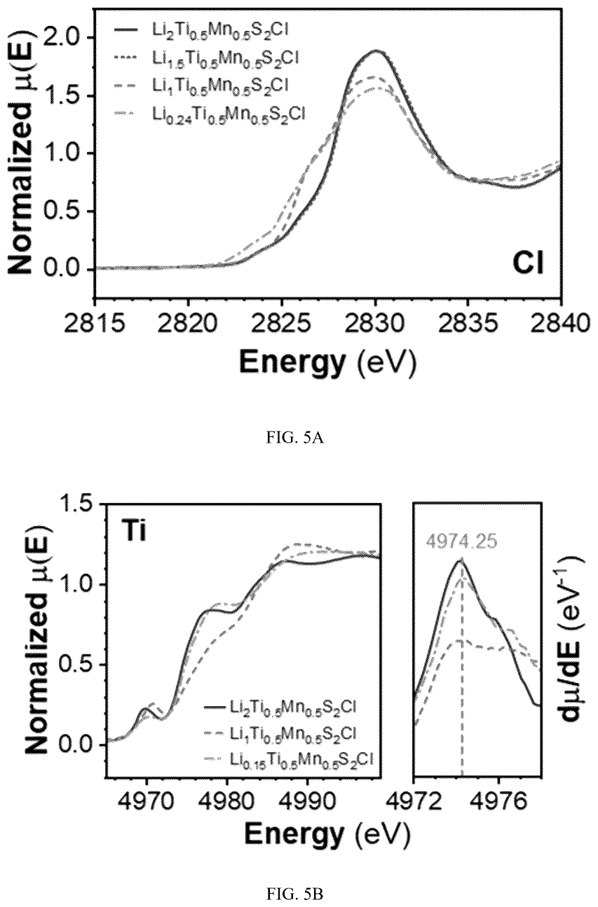

A sloping oxidation/reduction behavior was measured for sulfochlorides, suggesting a solid solution behavior throughout the Li-ion insertion process. The averaged potential recorded for the sulfochlorides is greater by ~400 m V compared to that reported for Li₂TiS₃. This rise in potential can be explained by the decreased covalency of the transition metal-ligand bond when substituting sulfur by chlorine, which has a greater electronegativity (χ_{S}=2.58 and χ_{Cl}=3.16 in the Pauling scale). See FIG. 4.

### Example 4: Characterization of DRX Sulfochlorides by X-Ray Absorption Spectroscopy

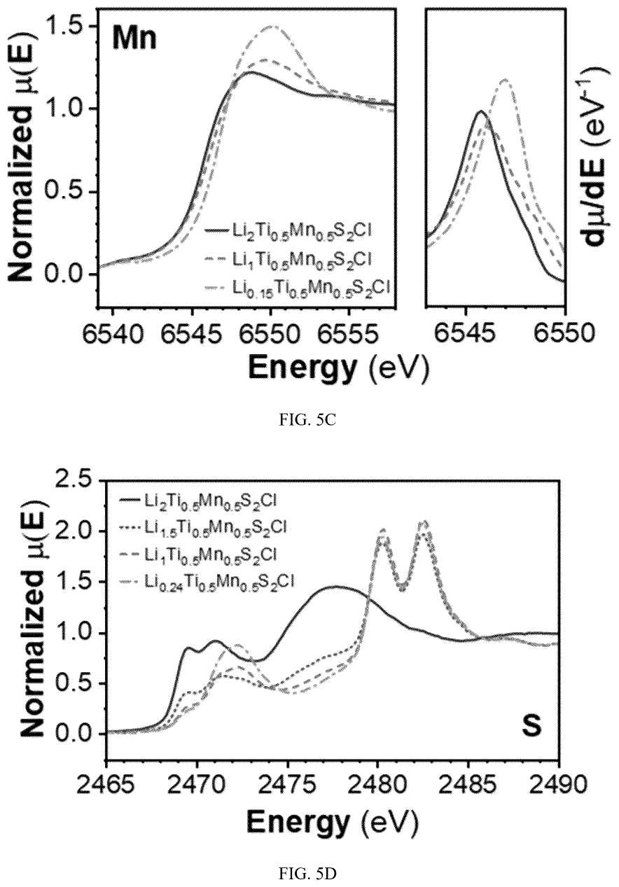

Ex situ XAS measurements were carried out at various edges to determine the redox active centers for each redox event FIG. 5A-5D. First, the Cl K-edge resembles that of LiCl at the early stages of oxidation (see FIG. 5A) while a shoulder similar to that observed in MnCl₂ is observed at full charge. This suggests that there are Li/Mn—Cl rich regions in LTMSC, and during Li⁺ de-insertion the Cl predominantly coordinates with transition metal (note that TiCl₄ is a liquid and therefore could not be measured). Second, the Ti K-edge rising edge does not shift during charge, indicating that Ti is not redox active and in an oxidation state of 4+ See FIG. 5B. However, the Ti K-edge spectra show a shift and broadening of the pre-edge peak, likely associated with the sulfur redox activity. This suggests that Ti is preferentially coordinated by sulfur ligands. For the pristine material, Mn is found in an oxidation state close to 2+, consistent with the formula Li₂Ti_{0.5}⁴⁺Mn_{0.5}²⁺S₂Cl for which the Ti⁴⁺ (d⁰) and Mn²⁺ (d⁵) configuration is favored compared to a Ti³⁺/Mn³⁺ due to the stability of the Ti⁴⁺ and that of Mn²⁺ in high spin configuration. Relative to the pristine material, the shift of the Mn K-edge is very small (0.2 eV) in the composition range of Liₓ Ti_{0.5}Mn_{0.5}S₂Cl with 2≤x≤1. See FIG. 5C. Instead, a shift of 1.2 eV is recorded after full charge (Li_{0.15}Ti_{0.5}Mn_{0.5}S₂Cl), indicating that the manganese is primarily redox active during the second part of the charge.

The sulfur K-edge of the pristine material shows two peaks at 2469.55 eV and 2471.15 eV (See FIG. 5D), similar to that observed for TiS₂, and characteristics of S₂-ligands. During oxidation, a new peak emerges at 2472.35 eV and continuously grows during the entire charging step. Density functional theory (DFT) calculations were carried out for various local environments (see Table 1 below) and confirm that sulfur is the main redox center), consistent with the high stability of Mn²⁺ and electrochemically inactive Ti⁴⁺ ions.

TABLE 1
Density functional theory calculations

| | | | | | |
|---|---|---|---|---|---|
| Rocksalt | E(eV/FU) | Bader Mn | Bader Ti | Bader S | Bader Cl |

Li₂Ti_{0.5}Mn_{0.5}S₂Cl

| | | | | | |
|---|---|---|---|---|---|
| Order #1 | −28.3707 | 5.79 | 2.40 | 7.16 | 7.82 |
| Order #2 | −28.4599 | 5.77 | 2.36 | 7.18 | 7.81 |
| Order #3 | −28.2044 | 5.78 | 2.39 | 7.19 | 7.78 |
| Order #4 | −28.4381 | 5.77 | 2.38 | 7.17 | 7.82 |

Li₀Ti_{0.5}Mn_{0.5}S₂Cl

| | | | | | |
|---|---|---|---|---|---|
| Order #1 | −19.6023 | 5.76 | 2.37 | 6.47 | 7.50 |
| Order #2 | −19.6732 | 5.83 | 2.42 | 6.45 | 7.49 |
| Order #3 | −19.8423 | 5.76 | 2.35 | 6.44 | 7.56 |
| Order #4 | −19.6264 | 5.74 | 2.40 | 6.45 | 7.53 |

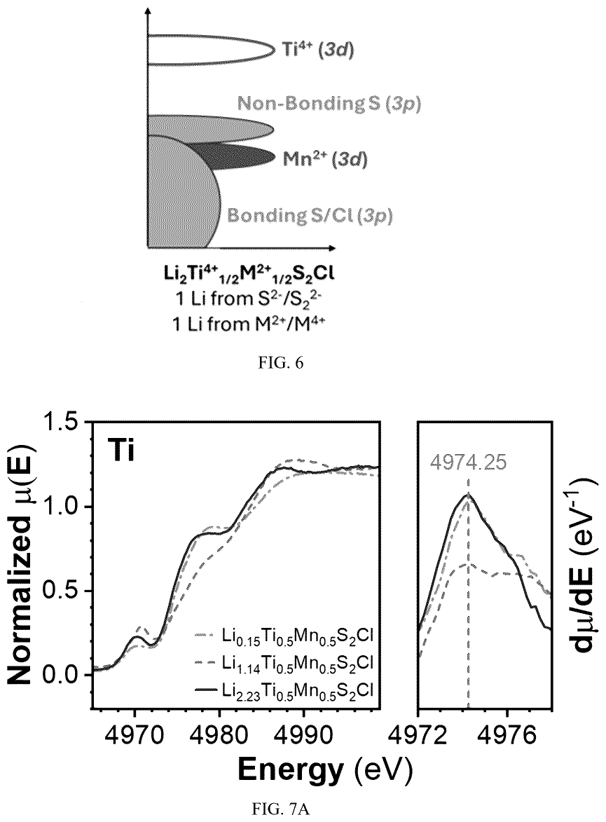

The results show that S is preferentially located in the vicinity of Ti, while Cl preferentially locates near Li and Mn, consistent with the conclusions drawn based on Ti and Cl K-edge measurements. DFT calculations also reveal that the degree of delithiation necessary to form these pairs is correlated with the amount of S coordinating Ti, e.g. TiS₆ local environments were found to form pairs earlier in charge compared with TiS₅Cl environments. Instead, no S—S pairs form in TiS₄Cl₂ environments, a local configuration that is statistically unavoidable due to the Ti to S/Cl ratio. Taken together, these results show that sulfur oxidation takes place throughout the entire charge step and is very sensitive to the local environment. Differently, Mn oxidation occurs during the later stages of charge, indicating that non-bonding S²⁻ 2p states are found at greater energy compared to cationic Mn—S antibonding states. See FIG. 6.

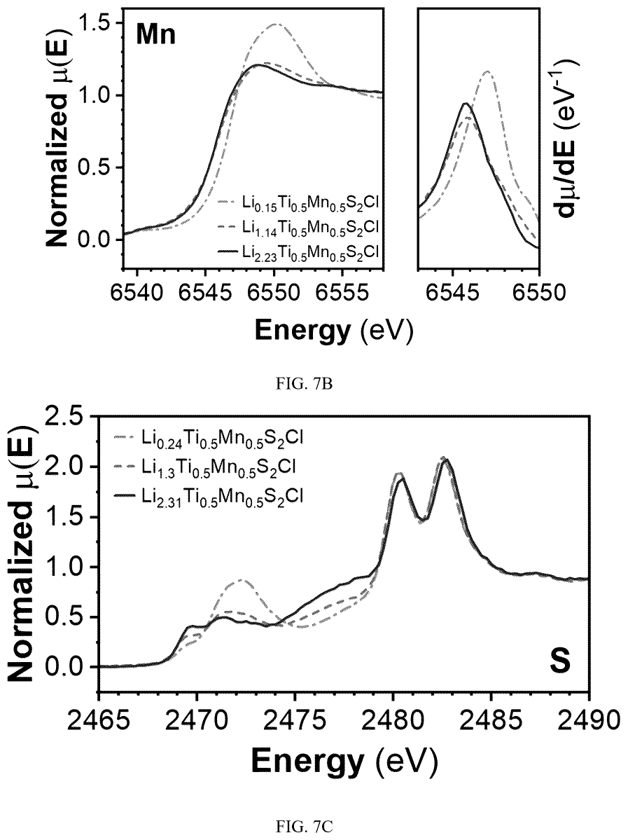

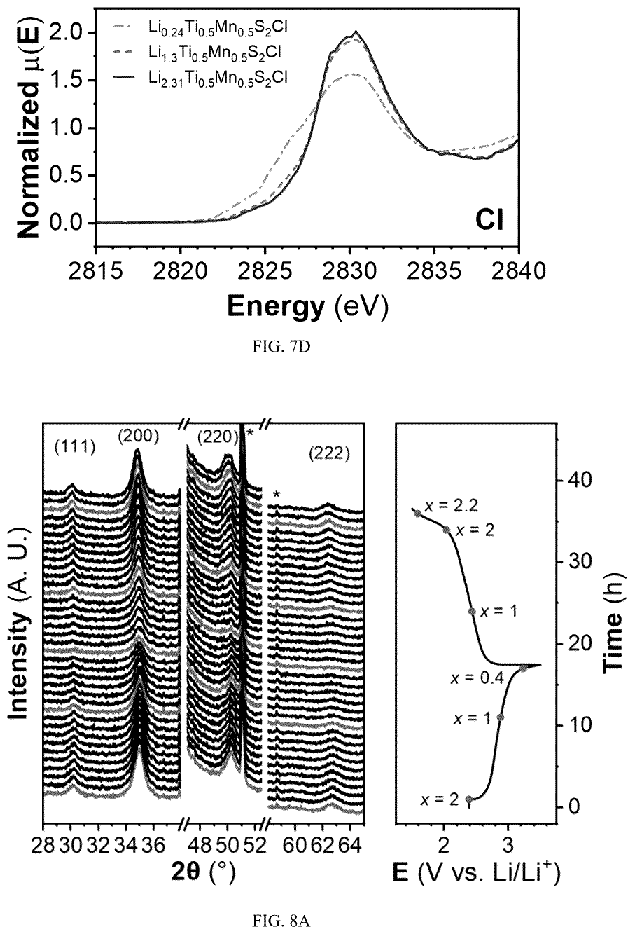

Upon discharge (re-lithiation), an increase in the pre-edge is observed at the Ti K-edge, indicating that changes in the local environment of Ti are, at least, partially reversible. See FIG. 7A. Similarly, XAS results during discharge show that Mn redox is reversible with the reduction happening during discharge in the composition range LiₓTi_{0.5}Mn_{0.5}S₂Cl with 0.24≤x≤1. See FIG. 7B. Instead, S ligands are reduced throughout the discharge but never comes back to the pristine states, with the peak corresponding to S₂-ligand never regaining its full intensity while that ascribed to the (S₂)²⁻ pairs remaining visible at the end of discharge. See FIG. 7C. This observation indicates that (S₂)²⁻ pairs are frozen in the structure, ultimately increasing the amount of charge that is balanced by the oxidation of sulfur during subsequent cycling. Finally, the Cl K-edge shows a reversible process when compared to that observed in charge (see FIG. 7D), with the shoulder observed at full charge and ascribed to a Mn-rich environment disappears, and the spectra resembles that of LiCl previously observed for the pristine sample at the end of discharge.

### Example 5: Characterization of DRX Sulfochlorides by Operando X-Ray Absorption Spectroscopy

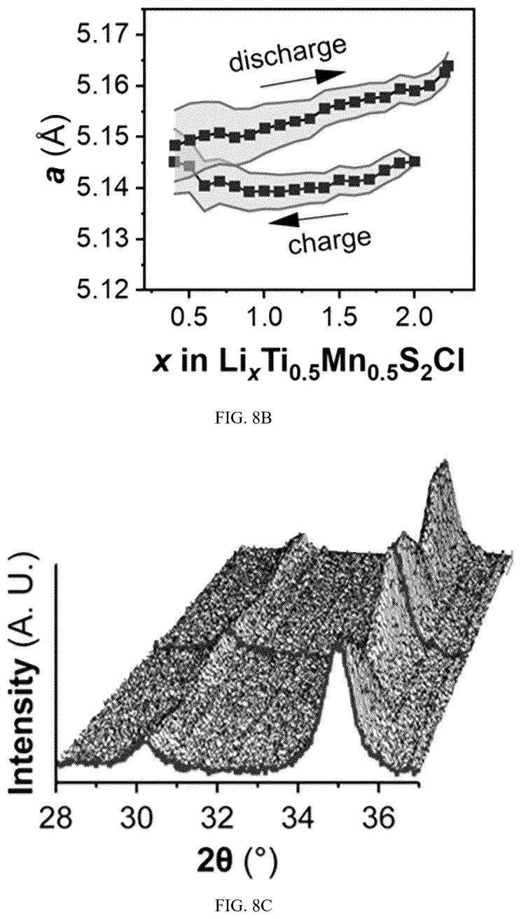

The structural transformations of LTMSC were tracked during the first cycle by operando XRD. FIG. 8A shows the evolution of the (111), (200), and (220) reflections from the Fm3̅m cubic structure. During the first charge, no changes are observed in the lattice parameters (See FIG. 8B. However, a noticeable drop in intensity was measured (see FIG. 8C), attributed to a crystalline-to-amorphous transition, consistent with observations previously made for DRX such as Li₂TiS₃. This is explained by the redox activity of the sulfur ligand that forms (S₂)²⁻ pairs which distorts the local environment around Ti, as observed both by DFT and XAS measurements at the S and Ti K-edges. During discharge, the peak intensity and thus the crystalline order in LTMSC is restored (see FIG. 8C), owing to the reduction of the (S₂)²⁻ pairs. However, this is accompanied by an increase in lattice parameter (see FIG. 8B), indicating irreversible changes occurring during cycling, consistent with the observation that the sulfur redox is not fully reversible. During the second cycle, the structural transitions matched those of cycle 1. Therefore, Li-ion (de)insertion leads to significant structural rearrangements that are largely reversible, at least during the initial cycles.

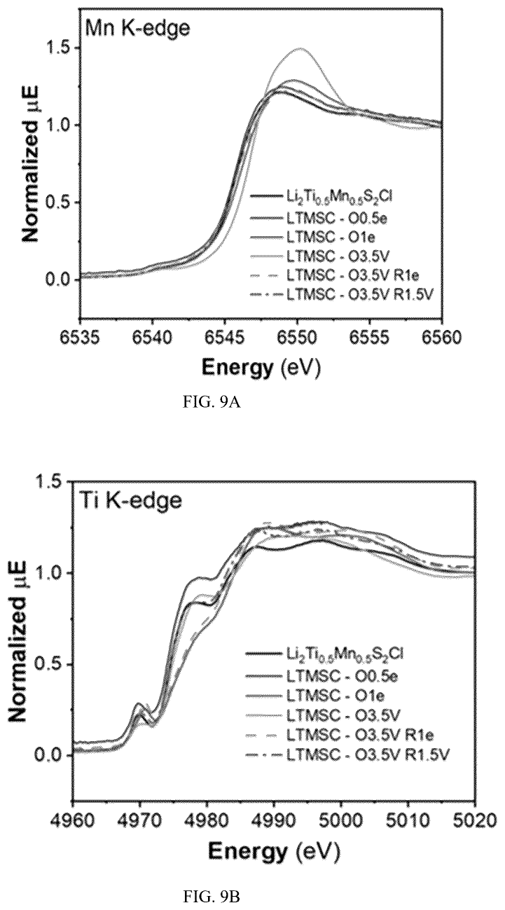

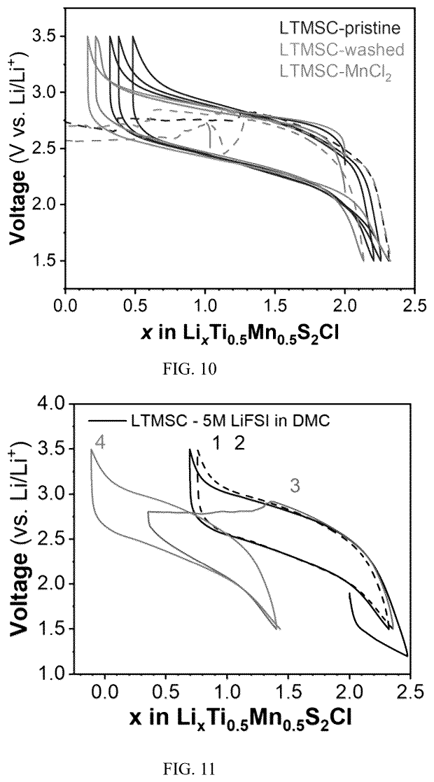

X-ray absorption spectroscopy (XAS) data collected at the Ti and at the Mn K-edge for Li₂Ti_{0.5}Mn_{0.5}S₂Cl at different charging states confirm the redox involvement of manganese and the sulfur ligand. See FIG. 9A. The Mn K-edge is found to shift to higher energy throughout the charging, indicating a continuous oxidation of Mn²⁺ to Mn⁴⁺. This result indicates that the cationic (Mn²⁺/Mn⁴⁺) and the anionic (S²⁻/S₂²⁻) redox couples are concomitant and occur simultaneously during the whole charge process, indicating overlap between the TM d band and the mixed anion p band leading to hybridization. In reduction, the Mn K-edge shifts back to its initial energy, indicating that the Mn redox is reversible during cycling. See FIG. 9A. Furthermore, the Ti K-edge was found to remain constant in energy throughout cycling, indicating the redox inactivity of Ti⁴⁺ in the cycling process. See FIG. 9B. However, the pre-edge was found dramatically impacted by the charging, with the reversible disappearance of the pre-edge peak at 4778 eV. Such observation can indicate a change in local coordination or a drastic change in Ti-Ligand bond overlap and/or covalent character.

### Example 6: Reversibility of Li (de)intercalation

The reversibility of the Li (de)intercalation in this novel DRX sulfochloride material was then studied upon prolonged cycling. During the second cycle, a parasitic anodic current was consistently observed at about 2.7-3 V vs Li⁺/Li throughout numerous cells. See FIG. 10. As seen in FIG. 11, LTMSC resumes its normal cycling, albeit with a steady loss of capacity, when the charging time is restricted to limit the parasitic reaction. It was confirmed that this behavior does not originate from the dissolution of the lithium chloride coating observed on the surface of the LTMSC. Indeed, similar observation was made for LTMSC washed with DMC (See FIG. 10) for which the LiCl shell was successfully removed, as shown by STEM/EDS mapping. This conclusion was further reinforced by observing that LTMSC synthesized using MnCl₂ instead of LiCl, potentially minimizing the amount of unreacted LiCl, undergoes a similar parasitic process during the second cycle (see FIG. 10). Thus, this detrimental phenomenon likely originates from an intrinsic property of the material.

To gain atomic-level insight into the origin of structural and chemical destabilization of LTMSC during coupled cation and anion redox, DFT calculations were performed on 4 unique structural configurations at zero state of charge (2 Li/f.u.) and full state of charge (0 Li/f.u.). The results revealed that TM coordination is a critical determinant in the material's stability. S—S pairs do not form in the Cl-rich TiS₄Cl₂ local environments. Nevertheless, statistically, the formation of these environments cannot be prevented for a composition of Li₂Ti_{0.5}Mn_{0.5}S₂Cl. The anionic redox accounting for the exchange of 1 Li in the phase, a third of the sulfur ligands must be oxidized to balance the charge. This cannot be accounted for only by the TiS₆ and TiS₅Cl environments, and at large delithiation content, sulfur ligands in Cl-rich TiS₄Cl₂ or Mn octahedra must participate to the charge balance. DFT results show that, for various local ordering, S—S pair formation is associated with dramatic structural reorganization, with the formation of S₂Cl or S—S—S species and metal-ligand decoordination. This observation is consistent with the operando XRD where amorphization is observed at the end of charge (see FIG. 4B) and it was concluded that such dramatic reorganization and changes in local coordination induces the release of Cl ligands on the surface of the material into the electrolyte. This conclusion is further reinforced by observing that the material remains active after this event, as observed when the extent of cell corrosion is limited (see FIG. 4B); this indicates that the process is likely limited to the material's surface. This finding motivates further efforts to stabilize electrochemical cells against chloride containing electrolytes as an important area for development that could extend the life of these high energy density cathodes.

### Example 7: Extending Cycling Ability

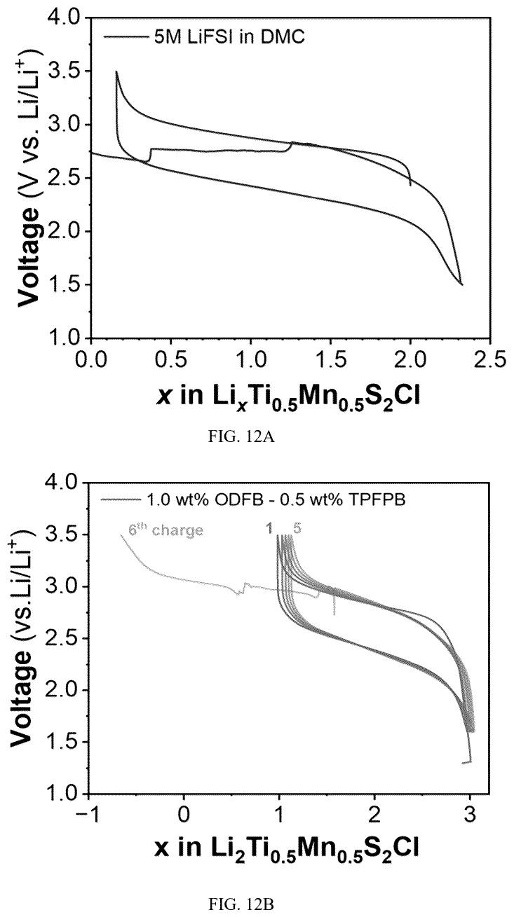

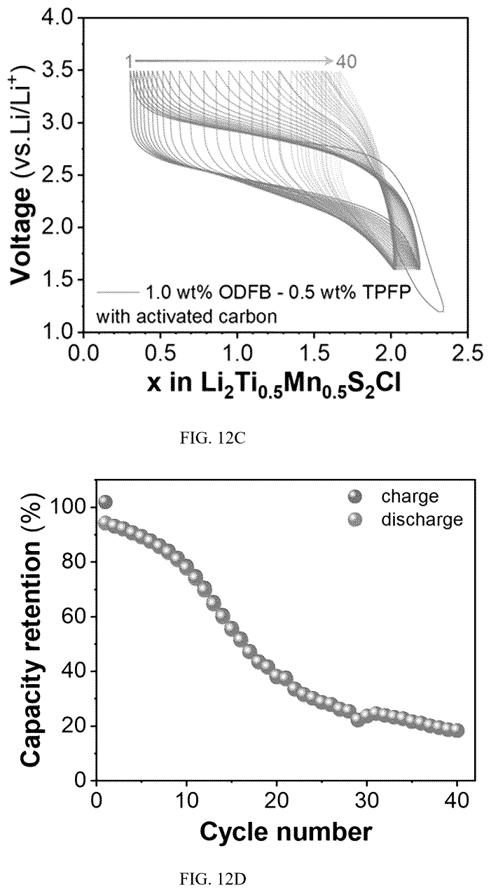

To further demonstrate this mechanism, an additives engineering approach was used to optimize both the electrolyte and the electrode to selectively chelate and absorb soluble chlorine species released upon cycling. Toward that goal, tris(pentafluorophenyl)borane (TPFPB) additive was used as chlorine scavenger. A second additive, lithium difluoro (oxalate)borate (LiODFB) was added to form a cathode electrolyte interphase (CEI); the formation is initiated during a first reduction/CEI forming step with a cutoff potential of 1.2 V vs Li⁺/Li, as observed during the first cycle in FIGS. 12B and 12C. To complement the use of electrolyte additives, activated carbon previously shown to prevent the release of soluble species was added to the electrode with the ratio of active material:carbon super P:activated carbon of 70:20:10. Note that the combination of these three additives is necessary to suppress the corrosion. With this optimized cell composition, no cell corrosion was observed and the intrinsic cycling ability of the LTMSC could be studied. After an initial capacity decay in the first 10 cycles of <20% of the initial capacity, a dramatic drop in capacity was observed in the subsequent cycles (see FIG. 12D). In detail, the capacity was found to drop by 80% after only 40 cycles. While chlorine loss upon cycling certainly contributes to this capacity fading, the result would be gradual. Instead, it is hypothesized that the irreversible sulfur redox, as observed by ex situ XAS analysis at the S K-edge, is instead responsible for the rollover of the capacity after the initial cycles, with manganese becoming the main redox active center after several cycles.

### Example 8: Decreasing the Anionic Redox Activity by Cationic Engineering

Altogether, the experimental and computation results indicate that the partially irreversible sulfur redox activity is at the origin for the degraded stability of the LTMSC sulfochloride upon prolonged cycling. To reduce the amount of anionic redox while sustaining a large capacity, a cationic engineering approach was utilized. In short, the ratio of redox inactive to redox active transition metal was decreased by substituting Ti⁴⁺ with Nb⁵⁺. As a result, and to maintain the charge neutrality of the material, the amount of Mn²⁺ was increased to form Li₂Nb_{0.33}Mn_{0.67}S₂Cl (LNMSC). Doing so, the manganese redox is expected to contribute to the exchange of 1.33 Li in LNMSC instead of 1 Li in LTMSC, thus theoretically reducing the sulfur redox activity to less than 1 Li (0.67) and potentially preventing the release of chlorine ligand in the electrolyte.

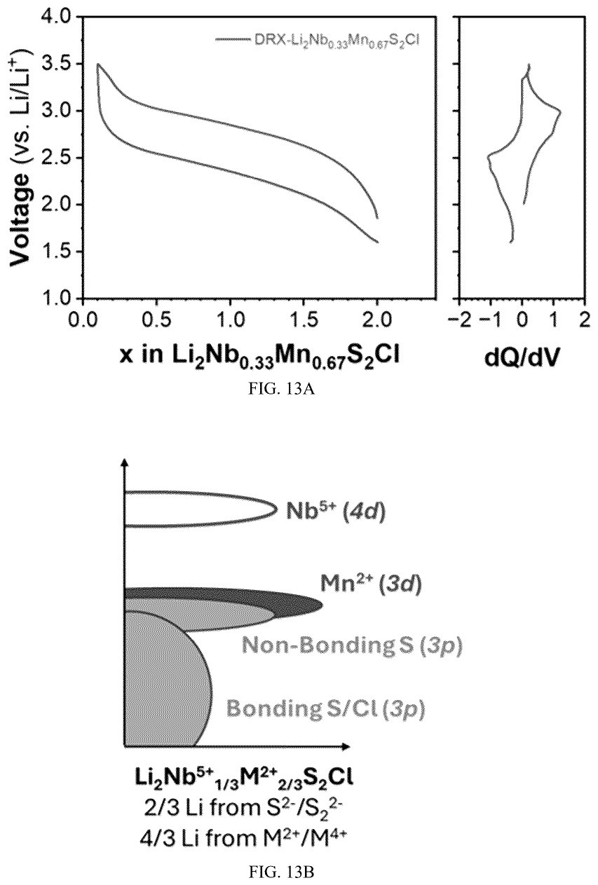

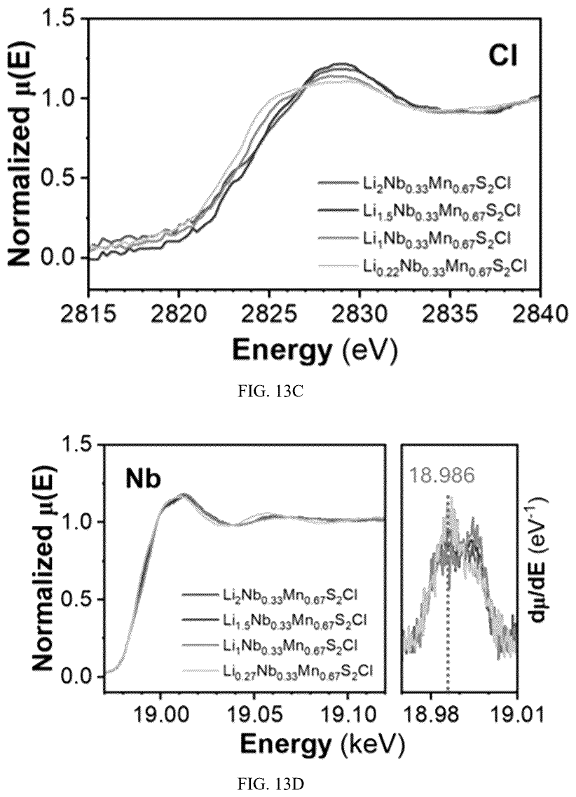

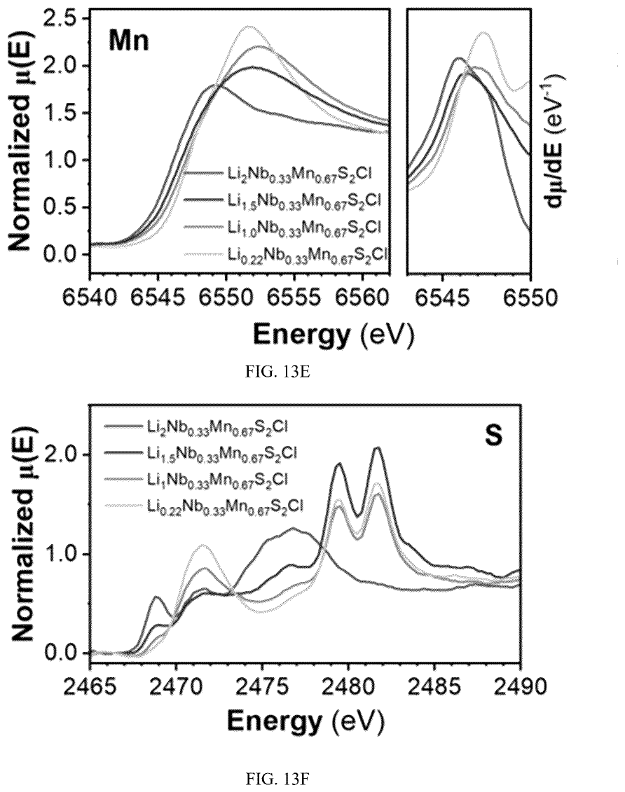

This Nb-based DRX (LNMSC) was successfully synthesized using a similar ball-milling process, and its redox activity estimated by electrochemistry combined with a combination of XAS at various edges. Like LTMSC, close to 2 Li are found to be reversibly exchanged in LNMSC, providing a capacity of 266 mAh/g. See FIG. 13A. Derivative dQ/dV curve indicates that two redox processes occur during cycling, the separation of which being greater than previously observed for LTMSC. See FIG. 13A. XAS at Nb K-edge confirms that Nb is redox inactive during cycling with the edge remaining at fixed position during charge and discharge. See FIG. 13D. Unlike in LTMSC, manganese in LNMSC is found to be redox active throughout the oxidation, and not only at the end of the charge, confirming the success of the cationic engineering approach to increase the cationic redox activity. See FIG. 13E. However, as indicated by the measurements at the S K-edge, sulfur is also redox active throughout the delithiation process, with the growth of the (S₂)²⁻ characteristic peak at around 2472 eV observed as early as for the composition of Li_{1.5}Nb_{0.33}Mn_{0.66}S₂Cl. See FIG. 13F.

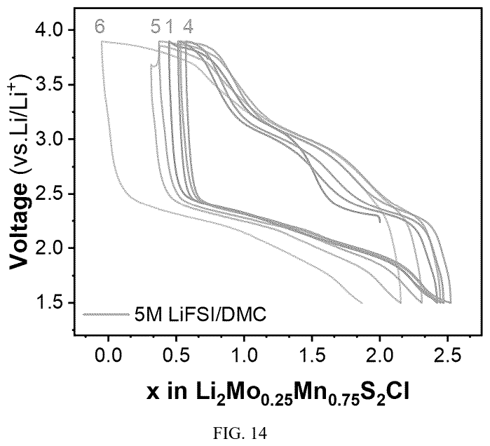

With the goal to push further the amount of cationic redox at the expense of the anionic sulfur one, Li₂Mo_{0.25}Mn_{0.75}S₂Cl (LMMSC) was prepared following a similar ball-milling process. Assuming redox state of Mo⁶⁺ and Mn²⁺ in the pristine state, the manganese redox would account for the exchange of 1.5 Li while the sulfur redox activity would only account for 0.5 Li. Using 5M LiFSi in DMC electrolyte, 2 Li were found to reversibly exchange corresponding to a capacity of 296 mAh/g. See FIG. 14. More importantly, unlike Ti⁴⁺ and Nb⁵⁺ containing materials that were found to lose capacity rapidly, LMMSC is found to possess a stable capacity, indicating that reducing further the S redox activity stabilize the phase. See FIG. 14. This represents a promising approach to stabilize sulfochlorides further and make them viable materials for application.

The above Examples characterize this first reported synthesis of sulfochloride materials crystallizing in a cation disordered rock-salt structure with the composition Li₂Ti_{0.5}M_{0.5}S₂Cl, M being a 3d transition metal in the 2+ oxidation state. Electrochemical tests reveal the reversible exchange of almost 2 Li per formula unit (~1.8 Li), providing a reversible capacity of 292 mAh/g (theoretical capacity of 325 mAh/g). XAS data confirm the involvement of both the transition metal and the sulfur ligands redox activity throughout the charge and discharge, unlike in sulfide DRX materials that only involve redox of the sulfur ligands. Finally, the use of superconcentrated electrolyte, such as 5 M LiFSI in DMC avoids issues with the solubility of the sulfochloride materials.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. Thus, other embodiments are also within the scope of the following claims.

1. An electrode material having the formula AₓTM1_{y}TM2_{z}SₐCl_{b}, wherein A is Li, Na, or K, TM1 and TM2 are the same or different and are each selected from a 3d, 4d, and 5d transition metal, x is 0 to 2.5, the sum of y and z is 1, the sum of a and b is 3, and b is greater than 0.

2. The electrode material of claim 1, wherein the 3d transition metal is selected from the group consisting of Ti, V, Cr, Mn, Fe, Co, Ni, and Cu; the 4d transition metal is selected from the group consisting of Nb, Mo, Ru, and Rh; and the 5d transition metal is selected from the group consisting of W, Re, Os, and Ir.

3. The electrode material of claim 1, wherein A is Li.

4. The electrode material of claim 1, wherein the material has a cation-disordered rock salt (DRX) structure.

5. The electrode material of claim 1, wherein b is 0.1 to 2.

6. The electrode material of claim 1, wherein TM1 is Ti, TM2 is Mn, y is 0 to 1, z is 0 to 1, a is 1 to 2.9, and b is 0.1 to 2.

7. The electrode material of claim 1, wherein TM1 is Nb, TM2 is Mn, y is 0 to 1, z is 0 to 1, a is 1 to 2.9, and b is 0.1 to 2.

8. The electrode material of claim 1 having the formula of LiₓTM1_{1-z}Mn_{z}SₐCl₃₋ₐ, in which TM1 is Ti or Nb, x is 0 to 2.5, z is 0.25 to 0.75, and a is 2 to 2.5.

9. The electrode material of claim 1, wherein x is 0.1 to 2.

10. The electrode material of claim 1, wherein y is 0.1 to 0.9 and z is 0.9 to 0.1.

11. The electrode material of claim 1, wherein a is 1 to 2.9 and b is 0.1 to 2.

12. The electrode material of claim 1 having one of the following formulas: LiₓTi_{0.5}Mn_{0.5}S₂Cl, LiₓTi_{0.25}Mn_{0.75}S_{2.5}Cl_{0.5}, LiₓNb_{0.5}Mn_{0.5}S_{2.5}Cl_{0.5}, LiₓNb_{0.33}Mn_{0.67}S₂Cl, and LiₓMo_{0.25}Mn_{0.55}S₂Cl, wherein x is 0 to 2.5.

13. A battery comprising a positive electrode, a negative electrode, and an electrolyte, wherein the positive electrode contains the electrode material of claim 1.

14. The battery of claim 13 wherein the negative electrode contains lithium, sodium, graphite, or any combination thereof.

15. The battery of claim 13, wherein the electrolyte contains a salt selected from the group consisting of LiClO₄, LiPF₆, LiBF₄, LiSbF₆, LiCF₃SO₃, LiN(SO₂CF₃)₂, LiN(SO₂C₂F₅)₂, LiN(SO₂F)₂, LiC(SO₂CF₃)₃, Li[N(SO₂C₄F₉)(SO₂F)], LiAlO₄, LiAlCl₄, LiCl, LiI, lithium bis(oxalato)borate, lithium bis(fluorosulfonyl)imide (LiFSI), NaClO₄, NaPF, NaBF₄, NaSbF₆, NaCF₃SO₃, NaN(SO₂CF₃)₂, NaN(SO₂C₂F₅)₂, NaN(SO₂F)₂, NaC(SO₂CF₃)₃, Na[N(SO₂C₄F₉)(SO₂F)], NaAlO₄, NaAlCl₄, NaCl, NaI, sodium bis(oxalato)borate, sodium bis(fluorosulfonyl)imide (NaFSI), or a combination thereof.

16. The battery of claim 15, wherein the salt is dissolved or suspended in a carbonate, an ether, an ester, a ketone, a nitrile, or a combination thereof.

17. The battery of claim 16, wherein the electrolyte is LiFSI or NaFSI dissolved in dimethyl carbonate (DMC) or dimethoxyethane (DME).

18. The battery of claim 13, wherein the electrolyte has a salt concentration of at least 3 mol/L.

19. The battery of claim 18, wherein the electrolyte has a salt concentration of 4.5 mol/L to 10 mol/L.

20. The battery of claim 19, wherein the electrolyte is LiFSI or NaFSI dissolved in dimethyl carbonate (DMC) or dimethoxyethane (DME).
